(19) United States
(12) Patent Application Publication
(10) Pub. No.: US 2015/0114515 A1
(43) Pub. Date: Apr. 30, 2015

(54) LIQUID FILLER USING SINGLE MOTIVE FORCE

(71) Applicant: ODEN MACHINERY INC., TONAWANDA, NY (US)

(72) Inventor: IVER PHALLEN, LEWISTON, NY (US)

(73) Assignee: ODEN MACHINERY INC., TONAWANDA, NY (US)

(21) Appl. No.: 14/529,142

(22) Filed: Oct. 30, 2014

Related U.S. Application Data
(60) Provisional application No. 61/898,458, filed on Oct. 31, 2013.

(51) Int. Cl. B67C 3/28; B67C 3/22; B67C 3/00

(52) U.S. Cl. CPC B67C 3/287; B67C 3/007; B67C 3/225
USPC 141/1; 141/238; 141/94

(57) ABSTRACT

A dosing method and apparatus for filling containers in an automatic in-line or linear liquid filling machine where a single positive displacement dosing apparatus produces a repeatable volumetric or net weight master dose which is precisely subdivided hydraulically into a plurality of equal and repeatable subdoses. Each equal subdose synchronously fills a container such that with each dosing apparatus cycle all containers are simultaneously and equally filled. A precision dose control is located in each subdose flow branch.

### TECHNICAL FIELD

The present invention relates generally to liquid dosing of containers and more particularly, a dosing apparatus for producing highly accurate and repeatable dose amounts for precisely filling containers using only a single motive force to produce the doses such that with each dosing apparatus cycle all containers are substantially simultaneously and equally filled.

### BACKGROUND OF THE INVENTION

Liquid filling machines of many types and categories are well known in the patent arts and in commercial practice. One broad category of automatic liquid fillers is termed the in-line or linear liquid filler.

In terms of container motion through the machine, in-line filler types may be of intermittent container motion or continuous container motion, although the former greatly dominate in usage. With continuous motion types, containers are filled in groups, corresponding to the number of filling positions, as containers move continuously from the infeed of the machine to the outfeed. With in-line intermittent motion machines, containers are conveyed into the filling machine as a group. The container group is positioned and held stationary while each container within the group is completely filled with the requisite total fill or dose of liquid. After filling, the container group is conveyed to the discharge of the machine, a next group of containers are conveyed into the machine, and the sequence repeats.

Within the in-line filler category, automatic filling machines are further categorized and analyzed by type or methodology of induced liquid flow, termed motive force. The motive force to cause liquid flow in an automatic liquid filling machine can include gravimetric flow, pressurized vessel induced flow, and positive displacement pump induced flow.

Gravimetric flow rate can be controlled by the degree of elevation of the liquid above the point of dispense or by flow orifice size of the dosing mechanism. Gravimetric flow as a motive force for filling is tightly constrained to use only with free flowing, low viscosity, homogeneous liquids. Controlled pressure vessel induced flow as a motive force is mediated by the gas pressure applied to the liquid and is generally constrained to low to medium viscosity homogeneous liquids, and to applied pressures of only a few Bars.

Motive force to induce liquid flow in an in-line filler is dominated in practice and usage by positive displacement pumps. By general definition, a positive displacement pump generates a defined liquid flow per increment of motion under a given set of flow conditions, with a given liquid. Many types of positive displacement pumps are known and utilized for liquid motive force in liquid filling machines. These include piston or linear displacement pumps, where flow rate is determined by speed of linear motion; and rotary motion positive displacement pumps, such as gear pumps, lobe pumps, circumferential piston pumps, progressing cavity pumps, sine rotor pumps, peristaltic pumps, where flow rate is defined by rotation rate; and diaphragm pumps where flow rate is defined by rate of diaphragm motion. In general usage, piston pumps and rotary displacement pumps dominate. Within the rotary pump subcategory, gear pumps and lobe type pumps (including circumferential piston) are almost completely dominant in application. This is because the range of usage and utility, termed machine versatility and flexibility, cannot be rivaled in performance by the other known and described container filling methods.

In-line fillers can be further categorized by means and method of defining a dose, the quantity of a given liquid to be filled into a given container. Gravimetric flow, with the source liquid level controlled allows volumetric dose definition by timed flow or by use of volumetric flow meter types. Use of a Coriolis mass flow meter allows the liquid dose to be defined on a mass or net weight basis. Controlled pressure vessel induced flow allows volumetric dose definition by timed flow or by use of volumetric flow meters. Use of a Coriolis mass flow meter can provide a mass defined dose.

In the predominant cases of use of positive displacement pumps, volumetric dose is defined for piston or linear displacement types by control of stroke or increment of linear motion. Displacing the piston pumped liquid through a Coriolis mass flow meter allows the liquid dose to be defined on a mass or net weight basis. In the case of rotary motion positive displacement pumps, volumetric dose is determined by increment of pump rotation and displacement of the rotary pumped liquid through a Coriolis mass flow meter can provide a mass or weight defined dose.

Typically, in prior art designs, each dosing pump is controlled and operated by a separate servo mode motor drive, typically an electric servo motor and associated electronic controls. Taken together, this assembly may be termed a servo-pump. By example, a filler of known type with ten filling positions uses ten servo-pumps in its implementation.

The ability to use a single motive force in a filling apparatus, rather than a separate motive force for each filling position may reduce costs. Means of devising a single motive force (SMF) filler exist and include a gas head flow compensation methodology where changes in flow rates in asynchronously operated flow branches are attenuated using a passive or active gas dome. This method exhibits multiple positive displacement (PD) pump complexities and degraded performance capabilities, and requires a dose defining flow meter in each flow branch, negating much of the substantial cost reduction over the known and accepted multi-pump method.

In another SMF method, flow in each flow branch is diverted upon asynchronous completion of a fill dose in that branch. The method also requires a flow meter in each flow branch and suffers from the same list of shortcomings as in the gas head flow compensation method.

In most cases where in-line fillers are utilized with positive displacement dosing pumps, the configuration constituting the single largest commercial filling machine grouping, a discrete positive displacement pump is utilized as the dosing mechanism at each and every dosing position, requiring a complete duplication of all dosing hardware and controls at each position. So, for example, a six dosing position or six “filling head” machine would have six complete and separate dosing pumps, one for each filling location, while a ten-head machine would have ten dosing pumps. Each pump would be essentially identical with every other in the machine, and each pump would be associated with a separate drive mechanism, a separate reservoir or supply feed and connections, a separate dose defining mechanism (mechanical and/or electronic) and generally discrete controls for flow rate, dose, and for filling head or dosing valve control tied to that particular dosing head. A well-known example of a filler as described is the SERVO/FILL® manufactured by Oden Machinery Inc. of Tonawanda N.Y.

Further, if the filling machine were intended for net weight filling, it would conventionally have a Coriolis liquid mass flow meter located in the flow discharge pathway of each and every pump. A well-known example of a filler as described is the NET/MASS® manufactured by Oden Machinery Inc. of Tonawanda N.Y. (U.S. Pat. No. 5,996,650).

The result of the described conventional and known in-line filler machine architecture or layout is a machine with a high degree of complexity which is directly proportional to the number of filling positions, and a cost which is related to the number of filling positions.

### SUMMARY OF THE INVENTION

The subject matter of the present disclosure includes a filling machine for dosing and containers that eliminates the requirement for an expensive duplicate dosing pump and associated apparatus for each filling head of the machine. A single master dose pump is supplied with the liquid to be filled by a single outlet reservoir or by a single flow source liquid supply. A single master dose pump may operate as the single motive force to provide a master dose which is hydraulically subdivided into a plurality of equal subdoses. The single master dose pump may be a positive displacement pump that is adjustable in liquid flow rate in order to establish the desired rate of liquid flow through the entire liquid flow pathway of the apparatus and into the plurality of containers to be filled. In the liquid filling method and apparatus, the entire liquid flow pathway, from the master dose pump liquid supply to the plurality of liquid filling heads, when in operable condition, may be entirely hydraulic or liquid filled. The master dose provided by the master dose pump may be displaced into a liquid product dose distributor. The dose distributor hydraulically subdivides the master dose into a plurality of approximately equal subdoses, each of which is delivered into one of a plurality of subdose flow branches.

The construction of the entire liquid flow pathway of the liquid dosing method and apparatus is of sufficient dimensional precision that, with each subdose branch configured identically, the measured subdose at each dosing position may be within 3 percent or better of the mean of all subdoses as established by summing the synchronous subdoses measured at all operating dosing positions and dividing by the total number of operating dosing positions. Each separate subdose branch created by the liquid product dose distributor may have an adjustable liquid dose control in its liquid flow pathway. The liquid dose control in each subdose branch may be adjustable in conjunction with the liquid dose controls in all other operating liquid subdose controls in all other operating liquid subdose branches for the purpose of establishing each subdose to be equal in volume or weight to all other subdoses. The adjustment of each liquid dose control in each liquid dose branch may be done manually or automatically.

Each subdose branch in the plurality of subdose branches of the liquid dosing method and apparatus may be terminated with a precision fast acting dosing valve or filling valve or filling head; each filling head constituting one filling position or dosing position.

The calibrated master dose pump and the plurality of filling heads in the liquid filling method and apparatus may operate synchronously to produce a master dose subdivided to a plurality of equal subdoses, each equal subdose simultaneously delivered through its respective filling head. The master dose may be directly produced and defined by the single master dose pump and directly delivered to the liquid product dose distributor. The master dose may be defined and measured by mass or weight. The master dose may be produced by placement of a single Coriolis liquid mass flow meter, disposed between the outfeed of the single master dose pump and the infeed to the liquid dose distributor. The master dose defined and measured by volume may be produced by placement of a single volumetric liquid flow meter, between the outfeed of the single positive displacement master dose pump and the infeed to the liquid dose distributor. The master dose produced by the master dose positive displacement pump may be established in volume to be equal to the desired volumetric sum of all subdoses in the plurality of subdoses. The master dose produced by the master dose mass meter may be established in mass or weight to be equal to the desired mass or weight sum of all subdoses in the plurality of subdoses.

The master dose expressed in volume or weight, may be defined and established by the formula:

M_{D}=S_{D1}+S_{D2}+ . . . +S_{DX} (1)

where M_{D} is the weight or volume of the master dose, and S_{D1} through S_{DX} are the weights or volumes of the individual subdoses and X is the number of subdoses.

Thus, the master dose, expressed in volume or weight, can be defined and established by the formula:

M_{D}=S_{DT}×X (2)

where S_{DT} is the desired subdose target set point expressed in volume or weight.

The calibrated subdose, expressed in volume or weight, can be defined and established by the formula:

S_{DC}=M_{DC}÷X (3)

where S_{DC} is the calibrated subdose, M_{DC} is the calibrated master dose.

The sequence of calibration leading to subdoses that are equal to one another and to the desired or target volume or weight may begin with adjusting the master dose to be equal to the target subdose weight or volume multiplied by the number of dosing positions, as given by formula (2).

The volumetric displacement dose produced by the master dose positive displacement pump may be conventionally measured and established by a preset pulse count, pulses being generated by a linear or rotary encoder. Alternatively, the volumetric dose produced by displacement flow of the master dose pump through the single volumetric liquid mass flow meter may be conventionally measured and established by a preset pulse count, pulses being generated by the volumetric flow meter. In another alternative embodiment, the mass or weight dose produced by displacement flow of the master dose pump through the single Coriolis mass flow meter is conventionally measured and established by a preset pulse count, pulses being generated by the mass flow meter.

The master dose calibration may begin by measuring the total or summed weight or volume of all synchronously filled subdoses, together constituting a trial master dose, and by counting the total trial dose pulses generated by the master dose pump encoder or the master dose volumetric or mass flow meter. The volumetric or mass dose of the master dose pump or master dose flow meter may be adjusted to calibrate or establish the target master dose by use of the following formula

$$\frac{TARMD}{TRIMD} \times TRIMDPC = TARMDPC \qquad ( 4 )$$

where TARMD is the target master dose, TRIMD is the trial master dose, TRIMDPC is the trial master dose pulse count, and TARMDPC is the target master dose pulse count.

The calibration of each dose branch in the plurality of dose branches to equalize each subdose to all other subdoses in the plurality may occur after the master volumetric or weight dose set point has been established and may be accomplished by subdividing the calibrated master dose into equal parts, each an equal fraction of the whole, using the adjustable dose control located in each dose branch. When the subdose is reduced by adjustment of the dose control in a given flow branch to correct for a subdose which is too large, the subdose will increase at all other operating flow branch subdose positions. Conversely, when the subdose is increased by adjustment of the dose control for a given flow branch dosing position to correct for a subdose which is too small, the subdose will decrease at all other operating flow branch dose positions. In either case, the change in subdose in any one of the unadjusted dose positions will be ratiometric and proportional to the summed subdoses of all of the unadjusted dose branches.

Each subdose may be equalized to achieve a target subdose by manipulation of each dose control in conjunction with all other operating dose controls.

Each dose control may be identical to all others in the operating apparatus and each dose control may be adjustable manually or automatically to effect an increase or decrease in subdose delivered through its dose branch. Each dose control may be adjustable manually with use of an increment of movement register or scale associated with each dose control adjustment mechanism, and where each dose control may be adjustable automatically by use of a pulse count from an adjustment actuator associated with each dose control.

Each dose control may initially be in a neutral dose adjustment position prior to subdose adjustment and calibration, allowing the dose branch subdose to be increased or decreased by a similar range or increment as necessary. The adjustment of the dose control may be incremented in weight or volume calibrated scale divisions denoting the amount of subdose adjustment, or in weight or volume calibrated pulses per increment of subdose adjustment, the divisions or pulses incrementing up and down from a zero or neutral position and defining positive adjustment (larger subdose) and negative adjustment (smaller subdose).

All operating dose controls in a plurality of dose controls may be initially calibrated by first cycling the master dose pump to produce a first sample subdose at each dosing position; and then measuring the sample subdose at one dosing position; and then adjusting the dose control at that dosing position up or down by an arbitrary number of increments or pulses; and then cycling the master dose pump to produce a second sample subdose at each dosing position; and then measuring the second sample subdose at the same dosing position; and then applying the two subdose measurements to the following dose control calibration formula:

$$\frac{FTD - STD}{SI} = CUPI \qquad ( 5 )$$

where FTD is the first trial dose in weight or volume, STD is the second trial dose in weight or volume, SI is the number of adjusted dose control scale increments, and CUPI is the resulting dose control calibrated units per increment value expressed in weight or volume per scale increment.

All operating dose controls in a plurality of dose controls can be successively and repeatedly adjusted for improved calibration accuracy by first measuring the average quantity of dose change for all subdoses resulting from a previous adjustment and calibration; and then correspondingly averaging the scale increments or divisions or pulses for all operating dose controls adjusted in the same previous adjustment and calibration; and then applying these data to the following dose control calibration formula:

$$\frac{ADC}{ASI} = RCUPI \qquad ( 6 )$$

where ADC is the average dose change across all of the operating dosing positions, ASI is the average scale increments of dose control adjustment across all of the operating dosing positions, and RCUPI is the resultant recalibrated units per increment of dose control adjustment.

Each subdose adjustment and calibration begins with the collection and measurement of a trial subdose for each operating filling head. Each trial dose is utilized in the dose control adjustment procedure using the formula:

TARSD−TRISD=SDE (7)

where TARSD is the target subdose in units of weight or volume, TRISD is the trial subdose in units of weight or volume, and SDE is the subdose error in units of weight or volume, and where a positive (+) subdose error signifies a required upward adjustment of the dose control to increase the subdose, and a minus (−) subdose error signifies a required downward adjustment of the dose control to decrease the subdose.

Each trial subdose error derived from the equation given in equation (7) is used to adjust each corresponding dose control using the formula:

$$\frac{SDE}{CUPI} = SIC \qquad ( 8 )$$

where SDE is the positive or negative subdose error, CUPI is the calibrated units per increment of adjustment of the dose control, and SIC is the number of dose control adjustment scale increments to correct the trial subdose, where a positive (+) result requires an upward adjustment of the dose control to increase the subdose, and where a negative (−) result requires a downward adjustment of the dose control to decrease the subdose.

The adjustable dose control for each subdose filling head or filling position may be adjusted as set forth in previously prior to collection and measurement of a second trial dose from each filling position.

The complete subdose calibration sequence described in equations (7) and (8) may be repeated on all subdose filling positions until all subdoses are within an acceptable percent or measured increment of the common target subdose set point.

The effect of dose adjustment of the adjustable dose control for one filling head upon the dose setpoints of the remaining filling head positions decreases ratiometically as the number of operating filling heads increases, such that the dose change is proportional on all unadjusted heads but the magnitude of the change on each filling head is reduced.

One to three repetitions of the calibration sequence described in equations (7) and (8) are generally sufficient to achieve a subdose set point accuracy of plus or minus one percent of the target subdose common to all filling positions. After the desired master dose has been established, an alternative method of subdose adjustment and calibration may begin with dose cycling the apparatus to produce a synchronous subdose at each filling head and then the collection and measurement of one dose head subdose from a first filling head, with the dose error of that filling head determined and adjusted using the formulas and method given in equations (7) and (8). After adjustment of the dose control for the first subdose filling head, the filling apparatus is dose cycled, producing a synchronous subdose at each filling head. This described process is then repeated on a next filling head, and then the process is repeated sequentially, one filling head at a time, until each operating filling head in the plurality of filling heads has been discretely and sequentially adjusted. This one head at a time method is continued in sequence until all subdoses are measured to be within an acceptable plus or minus percent or measured increment of the common target subdose set point.

One to three repetitions on each filling head of the second calibration method set forth in equation (8) are generally sufficient to achieve a subdose set point accuracy of plus or minus one percent or better of the target subdose common to all dosing positions.

In direct comparison with known prior art positive displacement pump liquid dosing designs, the amount of functionally identical apparatus to implement a complete filling position with the present invention is reduced ratiometrically as the number of filling positions to be implemented increases. This reduction is expressed quantitatively as a percentage reduction by the formula:

1−(1÷DPx)×100=PR (9)

where DPx is the number of dosing positions, and PR is the percent reduction. The comparative ratiometric reduction in apparatus cited in equation (9) allows a corresponding reduction in overall machine size and footprint. The comparative ratiometric reduction in apparatus cited in equation (9) confers a corresponding ratiometric reduction in cleaning apparatus, cleaning time, cleaning liquid volumes consumed, and effluent volumes generated, when directly compared to known art liquid filling machines constructed with equivalent liquid flow pathway components and construction. The comparative ratiometric reduction in apparatus cited in equation (9) conserves a comparable range of use, utility of use and capability and span of application.

Expansion of filling heads requires only a change out or alteration of the dose distributor and the addition of a dose control, a filling head, and a subdose flow branch for each filling position to be added.

The repeatability error of the master dose may be distributed among the subdoses in dose ratio for each subdose, measured dose to dose or in a compiled average, so that the repeatability error of each subdose may be identical in percentage terms to that of the master dose.

Precise synchronous actuation, operation and closing of all functioning dosing valves may be electronically controlled, monitored and alarmed, assuring that asynchronous operation is prevented and thus preventing the hydraulic acceleration or increase of flow rate into containers being filled resulting from asynchronous dosing valve operation.

Filling heads may be grouped into two or more pluralities, all pluralities having the same number of filling heads, so that each container in a plurality of containers receives a calibrated subdose fill at a first indexed filling position and additional calibrated subdose fills at each subsequent and corresponding indexed filing position, until the subdoses sequentially and separately filled into each container sum to be the desired total container dose.

The subdose from each dose control may be further hydraulically subdivided into two or more fractions, so that each container in an indexed group of containers receives a fractional portion of its calibrated subdose at a first grouped indexing position, and additional fractions of its calibrated subdose at each subsequent and corresponding grouped indexing position, until the complete subdose is filled into each container.

The plurality of subdose flow branches from the distributor may be split into two equal pluralities, each plurality alternately dosing correct subdoses to container filling positions located on parallel container indexing lanes, for the purpose of implementing a dual lane output liquid filing machine providing higher output speeds.

All configuration and calibration data for operation of the dosing invention, including, but not limited to, master dose pump flow rate, master dose pump or master dose flow meter dose pulse count, dose control calibrations, adjustment position or pulse count for each dose control, and filling head size and type, may all be grouped and stored electronically for re-use as operating set up parameters, thus allowing filling of a particular liquid at a particular subdose into a particular container to be re-implemented without the requirement of repetition of a calibration procedure.

A single master dose sample filling head can be utilized to establish the desired master dose volume or weight in accordance with equation (2), using the calibration method disclosed in equation (4). In one embodiment, the present disclosure provides for the use of only a single dosing pump, a simple flow branch divider and a dose control fitted into each flow branch, and synchronously operating dosing valves to provide filling doses to any plurality of filling heads in an automatic filling machine. This dosing method and apparatus may be useable with containers filled in groups with a desired dose delivered into each grouped container with each filling cycle. It may use a positive displacement pump to generate the motive force for flow; and may determine and define container filling dose using known means and methods for positive displacement pump volumetric and net weight fills.

The reduced complexity of the method and apparatus in the present disclosure, while delivering fully comparable performance, confers an improvement in reliability and, as a corollary, reduced and simplified maintenance.

This dosing method and apparatus results in numerous advantages over known practice and designs. Using the apparatus and method of this disclosure, only one servo-pump is used, and therefore, only one dosing pump is used. The single dosing pump provides liquid to all dosing positions. Servo-pumps are expensive and relatively complex, and are often the most expensive discrete devices in the filling machine.

A significant reduction in the liquid flow pathway components allows simpler and more rapid cleaning with a lower volume of effluents. This reduces costs, speeds, changeover, and improves machine productivity.

A filler constructed using the disclosed filling and liquid flow pathway can be substantially smaller in dimensions over known designs. This size reduction frees up highly valuable manufacturing floor space.

Expansion of the number of filling heads to meet higher production needs on a machine embodying the new filling method and apparatus requires only a change in the branch flow divider, addition of dose controls, and addition and connection of filling heads.

The overall machine control structure and its cost, typically implemented using a programmable logic controller (PLC), are inherently simpler and lower respectively with the use of the method and apparatus set forth in the present disclosure.

In the case where net weight filling is implemented in the new invention using only a single Coriolis mass flow meter, compared with a flow meter for every head in older designs, the cost reduction and simplification is of similar magnitude to the cost reduction and simplification gained by the use of only a single servo-pump.

The new liquid filling method and apparatus are comparable in the range of use and application to known multi-pump designs, from the perspective of filling speed, range and types of liquids to be filled, filling or dose volume or mass, temperature range of operation, dose repeatability and set-point accuracy, and ability to operate in hazardous locations.

### BRIEF DESCRIPTION OF THE FIGURES

FIG. 1 is a schematic view of a first embodiment of the liquid dosing invention.

FIG. 2 is a schematic view of a second embodiment of the liquid dosing invention.

FIG. 3 is a schematic view of the first embodiment of the liquid dosing invention providing a master dose sample filling head.

FIG. 4 is a schematic view of the second embodiment of the liquid dosing invention providing a master dose sample filling head.

FIG. 5 is a schematic view of the first embodiment of a step filling arrangement of the liquid dosing invention.

FIG. 6 is a schematic view of the second embodiment of a step filling arrangement of the liquid dosing invention.

FIG. 7 is a schematic view of the first embodiment of a dual lane filling arrangement of the liquid dosing invention.

FIG. 8 is a side view of an example filling head.

### DETAILED DESCRIPTION

The present disclosure describes a liquid dosing or filling method and apparatus in which a single master dose pump is supplied with the liquid to be filled by a single outlet reservoir or by a single flow source liquid supply. In the liquid filling method and apparatus, a single master dose pump may operate as the single motive force to provide a master dose which is hydraulically subdivided into a plurality of equal subdoses. The dosing method and apparatus disclosed in this specification comprises several embodiments.

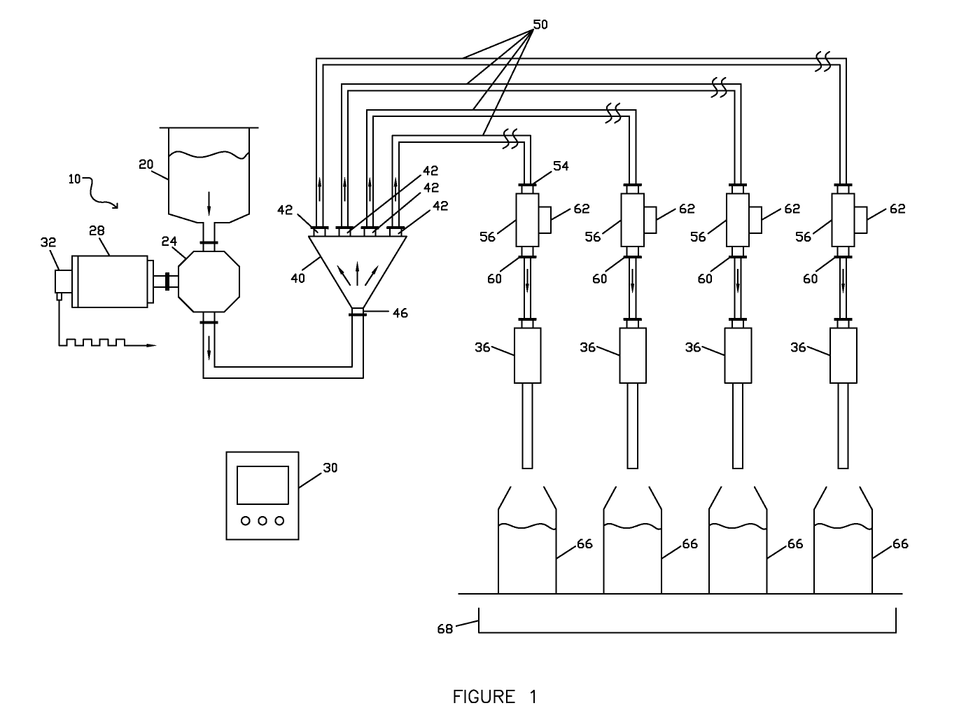

A first embodiment is disclosed in FIG. 1, and generally indicated by reference numeral 10. A liquid supply source, generally a supply reservoir 20, may be suitably sized to accommodate outflow demand and may be located proximate to the master dose pump 24. The supply reservoir 20 may be supplied with a suitable level control device (not illustrated) to allow for resupply from a bulk source. The supply can alternatively be a flow conduit from a remote bulk supply of the liquid to be dispensed.

The supply reservoir 20 is hydraulically connected to the master dose pump 24. The master dose pump 24 may be a positive displacement pump, and may be of any suitable positive displacement type. Some examples include linear piston pumps, and rotary lobe, gear and circumferential piston types. Progressive cavity, sine rotor, peristaltic, vane and diaphragm pumps may also be used.

The master dose pump 24 may be driven by an electric servo motor 28. Servo motor 28 may be rotary or linear in output and may directly drive the pump or may operate through suitable gear reduction. Alternatively, other conventional means of operating the master dose pump may be employed such as pneumatic or hydraulic drive arrangements. Controller 30 controls the operation of the pump.

In operation, the master dose pump 24 operates intermittently to produce a master dose based upon the displacement of the pump, at a suitable flow rate based upon the rate of motion of the pump. With piston pumps, the rate of linear motion defines flow rate, and with rotary positive displacement pumps, the rate of rotation defines the flow rate. A dose is produced by initiating the pump motion at the desired flow rate and subsequently ending the pump motion. This method for controlling dose flow rate and dose quantity is well known in the liquid filling art and is extensively practiced commercially, as with the PRO/FILL® and SERVO/FILL® products manufactured by Oden Machinery Inc. of Tonawanda N.Y.

Flow rate and displaced dose quantity are both derived electronically. In the case of linear displacement pumps, pump motion and rate may be measured using a measuring device 32 such as a linear encoder, linear variable differential transformer (LVDT), or similar, and the signals may be analog or digital. With rotary displacement pumps, the measuring device 32 may be an analog or digital rotary encoder, resolver or other measuring devices known in the art.

As understood by one knowledgeable in the liquid filling field, establishing and controlling the rate of flow of a particular liquid into a particular container is essential for correct filling and is widely variable in application, depending on such variables as container form, dose size, and liquid properties such as viscosity and foaminess. In the prior art, each filling head is supplied by a discrete positive displacement pump.

Referring again to FIG. 1, the entire liquid flow pathway is hydraulic in operation. The flow rate from any one of the plurality of filling heads 36A, 36B, 36C and 36D may be adjustably derived from the single master dose pump 24. The master dose pump 24 serves as the single motive force for liquid flow in the dosing apparatus. The master dose pump 24 must be sized and adjusted to produce a flow rate which is a multiple of the desired flow rate at each individual filling head.

This can be understood by example. Consider a four filling position version of the dosing apparatus as shown in FIG. 1, where each filling head defines a filling position. In this example, it is desired to have a range of possible flow rates from each filling head from near zero, up to 25 liters per minute maximum. To accommodate the maximum flow at all dosing positions, the master dose pump must provide a maximum flow rate of 100 liters per minute. This flow relationship, unique to this dosing apparatus, can be defined by the expression:

MDPFMAX=MFV×NFH (10)

where MDPFMAX is the master dose pump flow maximum required, MFV is the maximum flow required of any individual filling head, and NFH is the number of filling heads in the apparatus. The flow and dose from the master dose pump is equally divided among the plurality of dosing positions.

Liquid flow displaced by the master dose pump 24 is communicated via a suitable flow conduit to a dose distributor 40. Dose distributor 40 hydraulically subdivides the dose produced by the master dose pump 24 into a plurality of subdoses which are approximately equal to one another. As shown in FIG. 1, the liquid dose distributor 40 has four subdose branch flow outlets 42A, 42B, 42C, and 42D. However, the number of subdose branch flow outlets 42 may be more or less than four, and will be the same as the number of filling heads 36.

The dose distributor 40 may take many forms including, but not limited to, a horizontal or vertical cylindrical liquid manifold or a fabricated tubing branched array. As shown in FIG. 1, the distributor is a generally round conical structure, with liquid entry 46 at the bottom, and the subdose branch flow outlets 42 at the top, although other shapes and geometries could be used. The generally round conical structure provides a highly stable and repeatable hydraulic subdivision of the master dose with minimal flow turbulence and minimal flow induced pressure boundaries or anomalies within the distributor lumen. The aspect ratio of the distributor diameter to height may be at least 1:1 and preferably greater.

Each subdose flows out of the dose distributor 40 via a subdose branch flow outlet 42 and into a subdose flow branch 50. Each subdose branch flow outlet 42 may be manufactured to a tight tolerance to assure a relatively even division of the master dose among the plurality of flow branches 50. As shown, there are four subdose flow branches 50A, 50B, 50C, and 50D, but the actual number may be more or less, depending on the number of filling heads.

Each subdose flow branch 50 may comprise a flow conduit, typically a rigid tube or a flexible hose having a semi-rigid structure, suited to the flows, pressures, motions, and chemistries to which it will be subjected. The subdose flow branch 50 may be selected for its consistent repeatability of internal flow diameter, and may be found to be most suited when within two (2) percent of the supplier stated diameter, and more optimally, within one (1) percent. Each subdose flow branch 50 may be fabricated such that all subdose flow branches 50A, 50B, 50C, and 50D are within a net flow length of one (1) percent from one subdose flow branch to the next. Because of this and the dimensional precision of the subdose branch flow outlets 42, each subdose as measured at the discharge end of its subdose flow branch 50 is within four (4) percent of the mean subdose, where the mean subdose is defined by the sum of all subdoses, divided by the number of subdoses.

Again referring to the embodiment illustrated in FIG. 1, each subdose flow branch 50 terminates at the inflow fitting or port 54 of an adjustable dose control, 56A, 56B, 56C and 56D. Each of the adjustable dose controls defines a subdose to be delivered to a container. Each of the adjustable dose controls 56 found in the liquid flow pathway of each subdose flow branch 50 may be adjusted in conjunction with all others in the apparatus to achieve subdoses which are all approximately equal to one another. The subdoses may all be within a stated accuracy range relative to the mean subdose, where the mean subdose is defined as the sum of all subdoses in the apparatus divided by the number of subdoses.

The adjustable dose control 56 may be constructed of rigid materials suitable to the pressures, flows and chemistries of the anticipated service. Each adjustable dose control 56 may have flow pathway dimensions that are tightly controlled in fabrication, thereby enabling each adjustable dose control to be interchangeable with every other within the given dosing apparatus. Each adjustable dose control 56 may have an inflow port 54, and an outfeed port 60. Each adjustable dose control 56 may also have a dose adjustment mechanism 62. Each dose adjustment mechanism 62 may operate manually or automatically. Each dose adjustment mechanism 62 may be capable of altering the dose flowing through the device by an increment of at least ten (10) percent, measured by volume or weight. The adjustment of dose may be essentially linear within the adjustment range of the device.

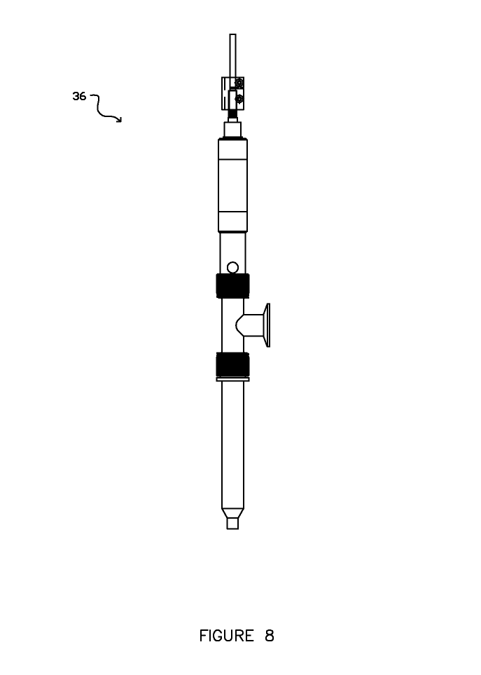

A conduit 64 may extend between the outfeed port 60 of each adjustable dose control 56 and the corresponding filling heads 36, and each branch may have an adjustable dose control and a filling head associated with it, and each filling head defines a filling position. These filling heads 36, also termed filling nozzles, dosing nozzles, filling valves, dosing valves, and dosing heads, may be of many known designs, depending on the nature and characteristics of the liquid being dosed, the dose size, and flow rates. A filling head is shown in FIG. 8, and is similar to the filling head shown in U.S. Pat. No. 6,669,051. However, other configurations of filling heads may be used. Each filling head 36 is actively valved to provide control of the flow capability and to allow each of the filling heads 36 to be opened or closed simultaneously. Controller 30 controls the operation of the filling heads. Each of the plurality of filling heads 36 may be dimensionally controlled so that interchanging the filling heads 36 with one another results in test doses that vary by no more than one (1) percent by weight or volume with respect to one another.

The operation of the filling heads may be repeatable from one operation to the next to within two (2) milliseconds of the desired duration. All filling heads 36 operate synchronously, even though the actuation of each individual filling head is discrete.

The synchronized opening and closing of each filling head 36 enables a single master dose to be divided into a plurality of equal subdoses using only a single dose-defining motive force. This method of operation also assures that there is no hydraulic acceleration of flow rate as would occur in any flow branch in which flow continued after the closure of one or more of the other dose valves in the apparatus. Such hydraulic acceleration would both alter the size of the subdose and create excess turbulence in containers being filled. The excess turbulence could result in the blow out of liquid from containers. Liquid dosing systems are generally adjusted to maximize the tolerable flow rate into containers in order to minimize fill time while maximizing machine output speed and productivity. Thus, there is little or no tolerance for asynchronous dosing valve operation.

The actuation time to open or close a filling head 36 is electronically measured for each filling head, with each actuation, thereby enabling the early detection and notification of any malfunction of any filling head 36. This, in turn, allows the prevention of incorrect or inaccurate fills or hydraulic accelerations of flow.

The dosing apparatus of this disclosure incorporates hydraulic subdivision of the master dose into equal subdoses. Therefore, it is preferable that all filling heads not only open and close at the same time and at the same rate, but also that any failure resulting in premature closing or shut-off of a filling head during a dosing event be detected. Such failure of a filling head may result in incorrect subdoses being delivered by the remaining functioning filling heads. Each filling head may be provided with an open-to-flow sensor (not illustrated). The open-to-flow sensor may be continuously monitored during a dosing event. The loss of full open status on any filling head may result in termination of the dose cycle and activation of an alarm (not shown). The alarm may specify the failed filling head.

In operation, the functioning filling apparatus is hydraulic, from the liquid supply 20 to the adjustable dose controls 56. As a result, the plurality of filling heads 36 operate synchronously with the master dose pump 24. This may be accomplished electronically by linking the opening and closing of the filling heads 36 to the master dose pump displacement motion. Thus, all filling heads 36 must be known to be open before pump displacement motion is allowed, and synchronized closing of all filling heads is not allowed until pump displacement motion is ended or nearly ended. One method for interlocking the pump displacement motion and the operation of the filling heads 36 is to interlock the signal that enables the operation of the pump drive to the filling head opening, and using a missing pulse detector circuit for detection of end of pump motion at the completion of a master dose. Those skilled in the art will recognize that many other methods may be used to accomplish the same result, and all fall within the scope of this invention.

It will be apparent to one skilled in the liquid dosing arts that many variations of the first embodiment of the invention are possible, all within the scope of the invention. In particular, the adjustable dose controls 56 can be directly connected to the subdose branch flow outlets 42 of the dose distributor 40. Likewise, the adjustable dose controls 56 can be directly connected to the filling heads 36, or incorporated in the dosing head structure.

FIG. 1 illustrates a plurality of containers 66A, 66B, 66C, 66D to be filled with liquid. As shown, the number of containers 66 is equal to the number of filling heads 36 in the dosing apparatus. The containers 66 generally may be resting on a moveable conveyor surface. The containers 66 are spaced and located under filling heads 36 by a conventional container indexing system 68.

The master dose pump 24 may be a positive displacement pump and as such, may define a master dose which is volumetric.

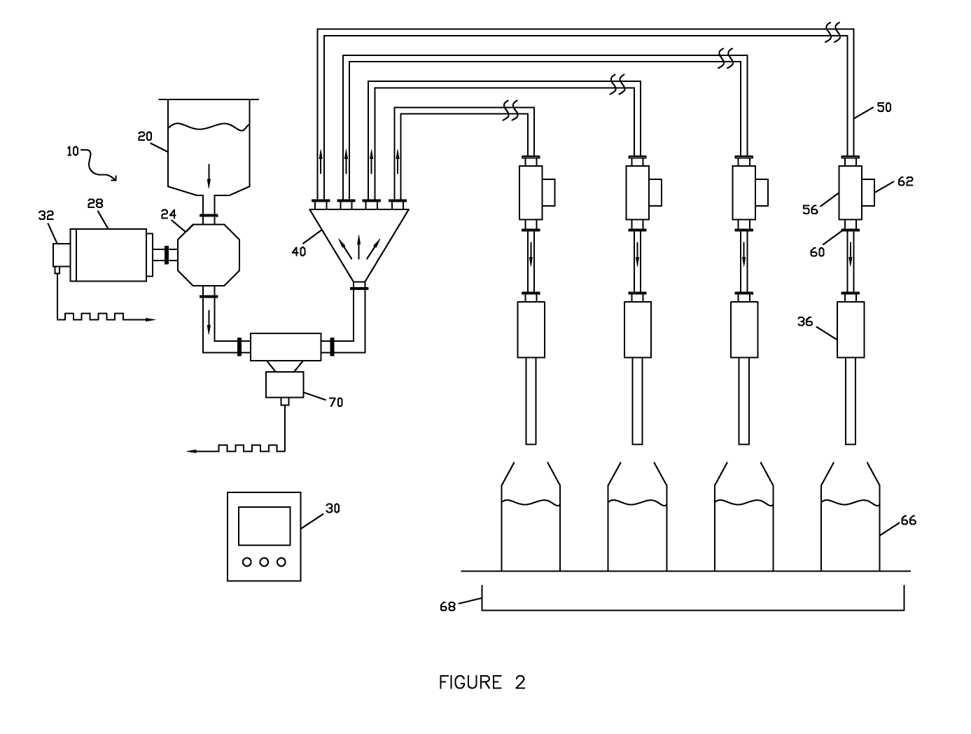

In a second embodiment, shown in FIG. 2, a liquid flow meter 70 is positioned in the liquid flow pathway between the outfeed of the master dose pump 24, and the liquid entry 46 of the dose distributor 40. The flow meter 70 may be a volumetric flow meter, such as a magnetic flow meter or another type of volumetric flow meter. Alternatively, the flow meter 70 may be a mass flow meter, such as a Coriolis mass flow meter or another type of mass flow meter.

When using a volumetric flow meter 70, master dose pump 24 provides the single motive force for liquid flow through the dosing apparatus, but does not define the volumetric master dose. Instead, the volumetric master dose is defined by the flow meter 70, generally as a pulse train output. In some cases, the master dose pump encoder pulses are counted and compared with the flow meter pulse count on a dose cycle by dose cycle basis as a means of providing checking, verification and validation of performance of the volumetric flow meter. Suitable data bases, averages, and alarm functions are provided.

When liquid flow meter 70 is a mass flow meter, the master dose is a mass or net weight dose, termed the master mass dose. In this embodiment, pump 24 provides the single motive force for liquid flow through the dosing apparatus, but does not define the master dose. Instead, the master mass dose is defined by the mass flow meter, generally as a pulse train output which is used as previously described for the master dose pump encoder. Dose comparison and alarming with the master dose pump as described for the volumetric flow meter case may also be used.

As previously discussed, each liquid flow component in each subdose flow branch is fabricated with a high degree of dimensional precision, allowing a relatively even division of the master dose to the plurality of subdose filling positions, even prior to dose control adjustment. This flow division relationship, from one flow branch to the next, may be preserved by a permanent marking affixed to each flow component, assuring that each component is replaced in the same flow branch position after removal for any reason.

The methods of configuring and calibrating the apparatus to establish a master dose and a plurality of equal subdoses will now be discussed in detail.

Because the apparatus disclosed in FIG. 1 and FIG. 2 is hydraulic in operation, the volumetric or master mass dose must be equal to the sum of all subdoses. Thus, for example, in a system with four subdose filling positions:

M_{D}=S_{D1}+S_{D2}+S_{D3}+S_{D4} (11)

where MD is the mass or volume of the master dose and S_{D1}−S_{D4} are the masses or volumes of the four subdoses. This expression can be generalized as:

M_{D}=S_{D1}+S_{D2}+ . . . +S_{DX} (12)

where X is the number of subdoses and S_{DX} is the mass or volume of the X subdose. When all subdoses produced from a single master dose cycle are collected and measured, the volume or mass of the master dose can be determined.

After the master dose has been adjusted and calibrated, and the dose control in each flow branch has been utilized to equalize each subdose, the mathematical relationship between the mass or volume of the master dose (M_{D}) and the mass or volume of the plurality of subdoses (S_{D}) can be expressed as:

M_{D}=S_{D}×X (13)

or

S_{D}=M_{D}÷X (14)

where S_{D} is the desired target subdose, and X is the number of subdoses in the operating plurality of dosing positions. Thus, to arrive at subdoses of the desired amount, the master dose should first be calibrated to be equal to a multiple of the desired subdose setpoint. The master dose calibration to meet this requirement can be accomplished using three different methods.

With the first method, a test cycle of the dosing apparatus is made and all subdoses are collected and measured. The total of either the volumes or the masses of all subdoses constitutes the trial master dose quantity. The total pulses generated by the master dose defining apparatus are noted, as previously explained. The master dose apparatus is then adjusted for its dose pulse preset using the following formula:

$$\frac{TARMD}{TRIMD} \times TRIMDPC = TARMDPC \qquad ( 15 )$$

where TARMD is the target master dose, TRIMD is the trial master dose, TRIMDPC is the trial master dose pulse count, and TARMDPC is the target master dose pulse count.

The calculated target master dose pulse count may be entered either manually or automatically into the electronic control system governing the operation of the master dose apparatus, and a second trial master dose may be collected and measured. If required, the master dose calibration sequence may be repeated until a master dose of the required amount is achieved.

This calibration process is repeated until the master dose is within the desired tolerance, preferably one (1) percent of the established target. This level of dose set point accuracy is typically achieved within three repetitions of the master dose calibration sequence.

With the second method of master dose calibration an approximate calibration of master dose is made, followed by equalization of each subdose. A final master dose calibration occurs after completion of the subdose equalization calibration sequence. This second method relies on the fact that each component of flow structure in the product distributor and in each flow branch are of sufficient dimensional precision that each unadjusted subdose is within five (5) percent of every other subdose. Therefore, users may make a first master dose test cycle and sample only one subdose. The subdose sampled may be used as the basis for one additional master dose adjustment (using the formula above) to arrive at a master dose that is within 5% of the desired dose size.

The second master dose adjustment method requires only two master dose calibration cycles and only two subdose samples. This contrasts with the first method wherein each subdose position may be sampled up to three times. Thus, for example, with ten filling positions the first method requires collecting and measuring thirty (30) subdoses, while the second method requires collecting and measuring only two (2) subdoses. Furthermore, and in contrast to the first method described, the second method does not require additional subdoses to be sampled with increases in the number of filling heads to be used.

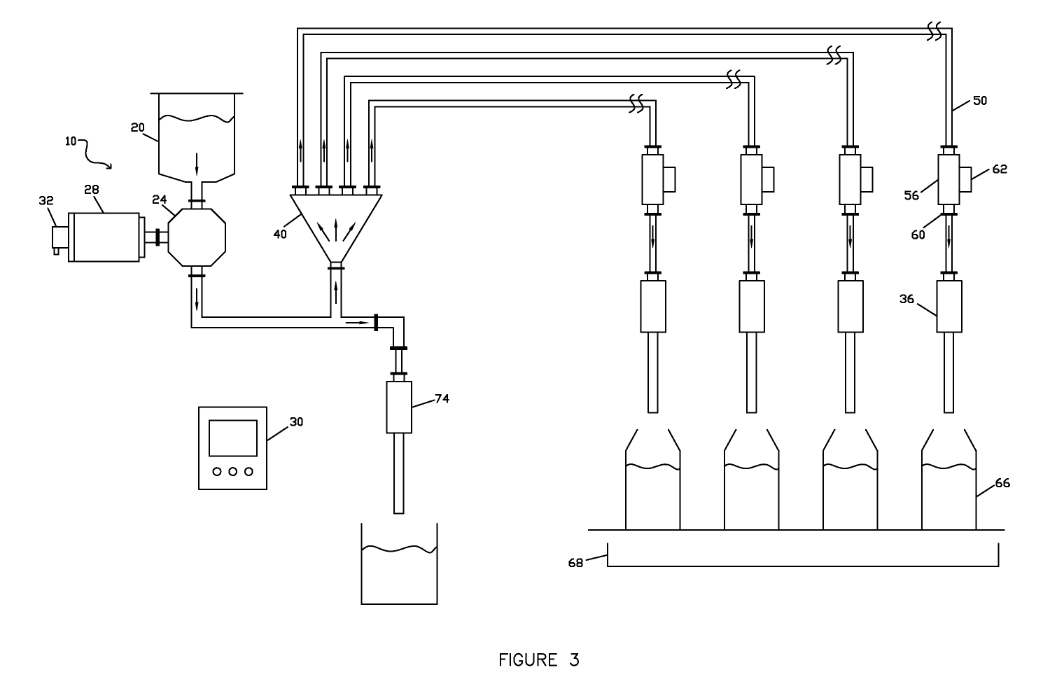

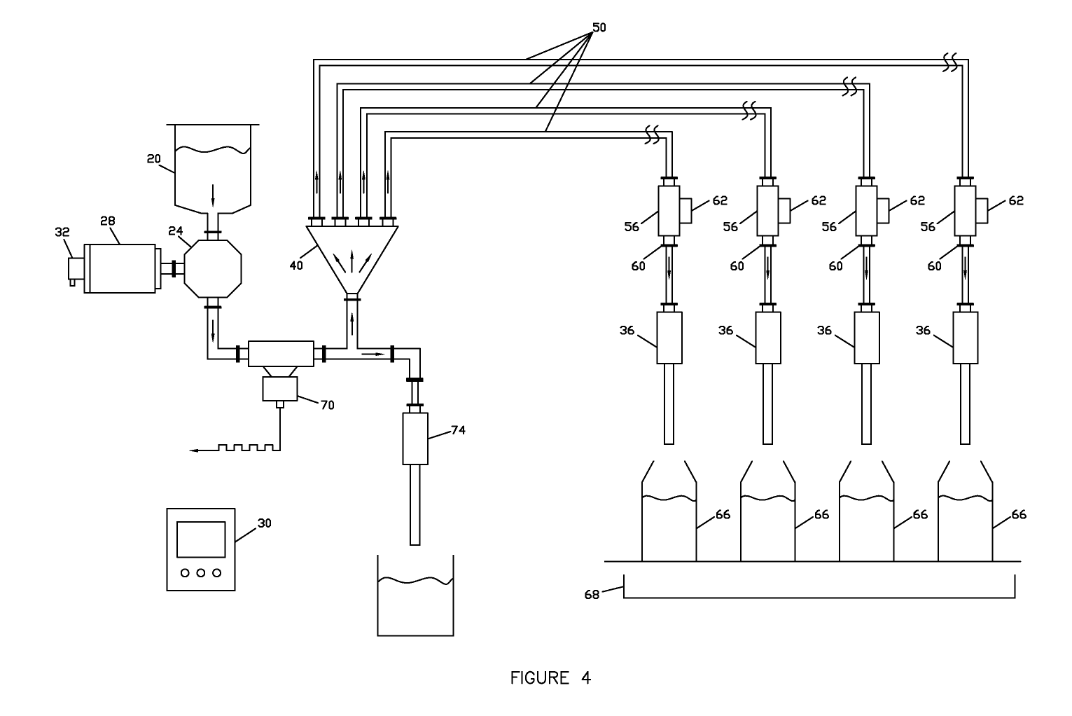

The third method of master dose calibration may be discussed by reference to FIGS. 3 and 4. The embodiment shown in FIG. 3 illustrates a master dose calibration filling valve 74 operable with the master dose pump 24. The embodiment illustrated in FIG. 4 shows a master dose calibration filling valve 74 operable with the master dose pump 24, and with liquid flow meter 70 positioned downstream from the discharge of master dose pump 24. This method allows direct sampling and adjustment of the master dose, with a single sample dose collection point. As with the first method, three (3) sampling and adjustment cycles are generally adequate to achieve a master dose set point within one (1) percent as measured by mass or volume of the desired master dose. In this method of dose calibration, filling heads 36 are initially disabled, and master dose calibration filling valve 74 is enabled, thereby enabling the collection of the entire calibration master dose in one location. When master dose pump 24 is used to define the master dose, there may be some change in the amount of liquid displaced per unit of motion of the pump as a function of a change in back pressure acting on the pump discharge. This change in back pressure may result from the different pump discharge flow structure acting on the pump when the master dose flows to the container filling heads, compared to when the master dose flows to the sample valves. Therefore, the third master dose calibration method may require a final calibration (generally the third master dose calibration cycle) after the dose controls have been adjusted. This final master dose calibration is completed by delivering the master dose to all synchronously operating subdose filling heads, and sampling one or more of the subdose filling heads.

As with all calibration and operating parameters for this dosing method and apparatus, the master dose calibration data may be stored in the electronic control apparatus of the invention. This data may be used to reconfigure the apparatus as desired from time to time.

The methods for adjustment and calibration of the plurality of subdose flow branches in order to equalize the target subdoses to be filled into containers will now be described.

The liquid dosing apparatus uses a hydraulic dose division apparatus to divide the master dose into equal subdoses, wherein each subdose constitutes a target container filling dose.

Division of a master dose into equal target subdoses may be accomplished by adjustment of the dose controls found in each of the plurality of subdose flow branches. Referring again to FIG. 1, adjustable dose control 56 may be either manually or automatically adjustable using dose adjustment mechanism 62.

The master dose is equal to the total of all subdoses for a given dosing episode, where a dosing episode is one sequence of filling a container at each filling head. The master dose may be divided into equal subdoses by dividing the mass or volume of the master dose by the number of containers to be filled in each dosing episode. For example, referring to FIG. 1, if the master dose is 1000 ml., each of the four containers shown will be filled with 250 ml. of liquid.

The adjustable dose control 56 in each subdose flow branch 50 may be adjusted as appropriate to increase or decrease the dose delivered to its filling head 36. The dose adjustment mechanism 62 is initially in a neutral or center position and may generally be varied to increase or decrease the dose amount by around ten (10) percent of the unadjusted dose. This range of adjustment is adequate to allow the adjustment of any given subdose to be equal to all other subdoses, since each unadjusted subdose is typically within five (5) percent of the average of all other unadjusted subdoses as discussed above.

Because the apparatus is hydraulic, any subdose portion which is altered in a given branch alters subdoses in all of the other branches as well. Thus, for example, if a subdose is increased in one branch, the subdoses in all other unadjusted branches will decrease. Conversely, if a smaller portion of the master dose is allowed in a branch by adjustment of the branch dose control, the subdoses in all other unadjusted branches will increase.

The increase or decrease in subdose from adjustment of a flow branch is ratiometrically distributed to each unadjusted flow branch in proportion to the ratio of the actual subdose on a given unadjusted flow branch to the sum of all subdoses from all unadjusted flow branches.

Two methods of subdose equalization adjustment will be discussed. In the first method, a trial subdose is collected and measured by weight or volume from each operating filling head in the apparatus. The difference in weight or volume of each of the trial subdoses from the target subdose, where the target subdose is common to all dosing positions, is determined. The increment of error is determined using the formula:

TARSD−TRISD=SDE (16)

where TARSD is the desired target subdose, TRISD is a trial subdose, and SDE is the subdose error. All terms are in units of volume or in units of weight.

If the trial subdose is below the target subdose, the dose control must be adjusted to increase the subdose. Conversely, if the trial subdose is larger than the target subdose, the dose control must be adjusted to decrease the subdose.

Each adjustable dose control 56 in each subdose flow branch 50 of the apparatus is substantially identical to every other. Each adjustable dose control 56 has a substantially identical dose adjustment mechanism 62. Each of the plurality of the dose adjustment mechanisms 62 may be digitized to allow manipulation based upon dose adjustment computations. In cases where the adjustable dose controls 56 are manually adjustable, the adjustable dose controls may have an incremented scale with a centerpoint reading zero, and graduations for negative adjustment for subdose reduction, and graduations for positive adjustment for subdose increase. The resolution of the scaled divisions may vary, but most typically are intended to adjust to one tenth ( 1/10) of a percent or less of the subdose setpoint. Adjustable dose controls which are automated may generally be controlled by the apparatus programmable logic controller (PLC), and may operate in the same manner as the manual version and with similar resolution.

Once the subdose error for each subdose has been computed, all dose controls may be adjusted as required. The increment of adjustment for each dose control requires calibration of the dose control itself, so that each scale or position sensor increment represents a known increment of actual dose change in weight or volume. The scaling of each dose control in a given operating apparatus may be treated as the same from one dose control to the next. Therefore, only one dose control need be initially calibrated, and the resulting weight or volume change per increment of adjustment may be utilized in all dose control positions.

Dose control calibration may be initially accomplished by moving the dose adjustment mechanism 62 on one adjustable dose control 56 by an arbitrary number of scale increments or divisions, and then cycling the dosing apparatus to produce a second set of subdoses on all dosing positions. On the one given sample dose position, the new subdose amount is measured and the result applied to the following dose control calibration formula:

$$\frac{( FTD - STD )}{SI} = CUPI \qquad ( 17 )$$

where FTD is the first trial dose in weight or volume, STD is the second trial dose in weight or volume, SI is the number of adjusted dose control scale increments, and CUPI is the resulting calibrated units per increment value expressed in weight or volume per scale increment.

For clarity, consider the following dose control calibration example:

First trial dose (FTD)=260 grams

Scale increments moved (SI)=25

Second trial dose (STD)=255 grams

Calibrated units per increment (CUPI)=0.2 grams

Each dose control is essentially linear in either direction of correction and as a result may be calibrated by increasing or decreasing dose. In the above example, the dose was decreased. Once determined, the dose control calibration for a given amount of liquid to be filled into a given container can be stored electronically along with the other configuration parameters set forth in this specification.

The dose control calibration method described is an initial or first calibration, and may be used for a first adjustment of each adjustable dose control 56. The accuracy of the initial dose control calibration may be improved as part of the subdose adjustment procedure.

Having established the error of each subdose based upon a first trial dose cycle of the apparatus, and having completed an initial calibration of the dose controls for each operating dose position using the dose control trial dose method set forth, each subdose may be adjusted to be equal to every other subdose where each subdose is of the desired fill weight or volume.

The first method for subdose adjustment consists of determining the correct dose control adjustment to be made at each filling head position, adjusting all positions, cycling the apparatus to produce an adjusted subdose at each position and measuring the resultant weight or volume for each.

Dose control adjustment is made by dividing each subdose error, whether positive or negative, by the calibrated units per adjustment increment, which yields the number of scale increments to be adjusted for that subdose. This computation is given by the formula:

SDE/CUPI=SIC (18)

where SDE is the positive or negative subdose error, CUPI is the calibrated units per increment of adjustment of the dose control, and SIC is the number of scale increments for correction of the trial subdose. A positive SIC result requires an increase in the subdose, and a negative SIC result requires a decrease in the subdose.

An example of this subdose adjustment procedure will help to clarify and illustrate this first method:

Consider a four filling head embodiment of the dosing invention as shown in FIG. 1, where the dose controls have been calibrated to a change in dose of 0.10 grams (g.) per increment of adjustment, and each desired subdose is 1000 g., giving a master dose of 4000 g.

The computation sequence would be as follows:

| | OPERATION | HEAD 1 | | HEAD 2 | | HEAD 3 | | HEAD4 | | |
|---|---|---|---|---|---|---|---|---|---|---|
| 1. | First Trial Dose | 970 g. | | 1030 g. | | 1020 g. | | 980 g. | | |
| 2. | Master Dose Check | 970 g. | + | 1030 g. | + | 1020 g. | + | 980 g. | = | 4000 g. |
| 3. | Subdose Error | +30 g. | | −30 g. | | −20 g. | | +20 g. | | |
| 4. | Dose Control | +300 | | −300 | | −200 | | +200 | | |
| | Adjustment Increments | | | | | | | | | |
| 5. | Theoretical New | 1000 g. | | 1000 g. | | 1000 g. | | 1000 g. | | |
| | Subdose | | | | | | | | | |
| 6. | Master Dose Check | 1000 g. | + | 1000 g. | + | 1000 g. | + | 1000 g. | = | 4000 g. |

Following this computation and adjustment sequence, the master dose pump 24 is again cycled, and subdoses are collected and measured at each filling head 36. Each subdose will be closer to the target dose value, but may not be at the target value. Accordingly, the computational sequence may be repeated, dose controls adjusted, and another set of subdoses collected and measured. With each successive adjustment and sample cycle, the number of increments adjusted decreases, and the dose error of each subdose decreases. Typically, after one to three adjustment cycles, each subdose is within an acceptable tolerance, generally one (1) percent of the target subdose. Thus, for example, on an apparatus with ten filling heads, subdose setpoints may be achieved with no more than 30 subdose samples, three at each position.

As with the other apparatus setup parameters, the dose control calibration settings for a given liquid and subdose may be electronically saved for recall and reuse. Thus, the described master dose and subdose calibration sequences may need to be done only one time.

With each subdose sample cycle, the accuracy of the dose control calibration used to adjust each subdose may be improved by measuring the increment of dose change for each subdose after an adjustment of the dose controls, averaging the increment of dose change across all subdose positions, and then correspondingly averaging increments or divisions or pulses of adjustment for all dose controls, and then applying these data to the following dose control calibration formula:

ADC/ASI=RCUPI (19)

where ADC is the average dose change across the operating dosing positions, ASI is the average scale increments of dose control adjustment across the operating dose positions and RCUPI is the resultant recalibrated units per increment of dose control adjustment.

With each subdose sample and adjustment cycle, the rate of adjustment improves, and therefore, the number of sample cycles to reach subdoses which are equal to one another and within the desired tolerance of subdose setpoint may be reduced.

As with the other apparatus setup parameters, the dose control calibration settings for a given liquid and a given subdose may be electronically saved for recall and reuse.

After subdose setpoint adjustment has been completed, the repeatability of each subdose from one dosing event to the next is a direct function of the repeatability of the master dose. Therefore, a given subdose repeatability error is related to the master dose repeatability error, and the percentage repeatability error of each subdose is the same as the percentage repeatability error of the master dose.

In a second method of subdose adjustment and calibration, the master dose pump is cycled, producing synchronous subdoses at all functioning filling heads. The subdose at a first position is collected and measured and the dose control on that head is adjusted according to the previously disclosed procedure. Then another dose cycle is initiated and the subdose at a next head is measured and adjusted. This sequence continues, one dose position at a time, until all filling heads have been adjusted. The process may then be repeated, and typically one to three samples per position are taken, until each subdose is within an acceptable tolerance of the target setpoint. The total number of subdoses to achieve calibration increases as the number of dosing positions in the apparatus increases, causing the use of a much greater amount of the liquid to be filled.

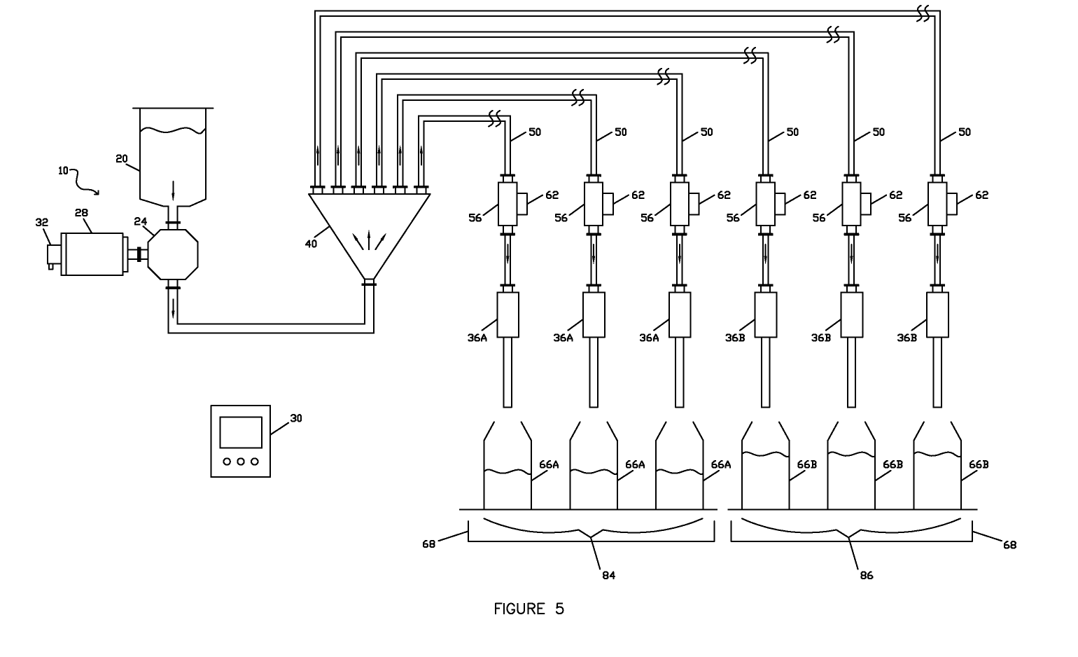

Referring now to FIG. 5, in another embodiment, the subdose produced by the adjustable dose control 56 on any given subdose flow branch 50 may be hydraulically subdivided into two parts to allow container step filling. The average of the divided subdose totals is equal to the desired subdose, which is equal to the desired target fill for each container, although the sizes of each of the two parts of the total subdose may differ from one another. Containers may be sequentially filled, first at a first filling head with a first portion of a subdose, then at a second filling head with a second portion of the subdose, thereby completely filling the container with the desired dose. For example, one container 10 may be partially filled at filling head 36A at the first index position 84 with a first portion of the subdose, then indexed to a second filling position 86 for the second portion of the subdose fill. Because the size of the first and second portions of each subdose are highly repeatable, the total dose received by each container using this method is as accurate in repeatability as in the case where the entire subdose is delivered by a single filling head.

This embodiment may be used where the behavior of the liquid being dosed limits the flow rate into the container, for example, due to turbulence effects or foaming. In these cases, by subdividing the subdose, the absolute fill time per indexing cycle may be reduced, and the flow rate into the container may also be increased, thereby reducing the fill time, and increasing the output rate of the machine. The subdivision of the subdose can be of any ratio desired since each container in the indexing queue is always dosed at its corresponding filling heads.

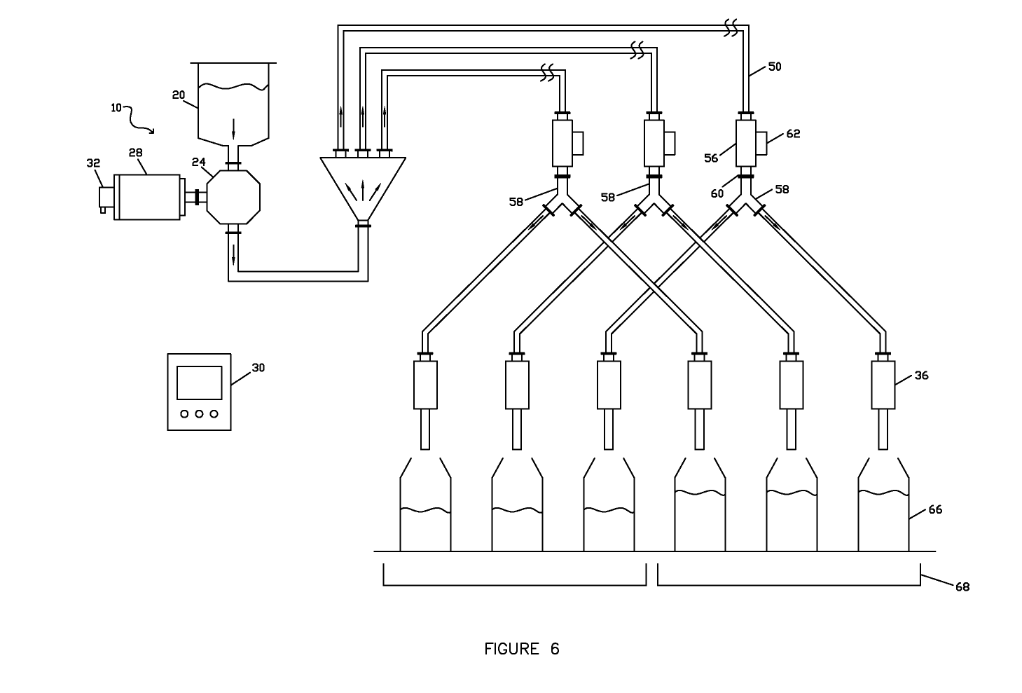

Alternatively, step filling may be implemented by indexing containers sequentially under two equivalent groups of subdose filling heads 36, each subdose position having its own adjustable dose control 56 as shown in FIG. 6. This method has all of the same capabilities and advantages as the previous method, but has greater complexity of calibration and setup and the higher cost of additional dose controls.

As shown in FIG. 6, a “Y” fitting 58 is disposed downstream of each adjustable dose control 56. However, the fitting could be of another configuration that divides the flow from the adjustable dose control 56 into two separate streams, such as a tee fitting. Conduits extend from each downstream end of the fitting 58 to a filling head 36. The fitting 58 divides the liquid stream into two substantially equal flows. This allows two containers to be filled simultaneously with equal portions of liquid.

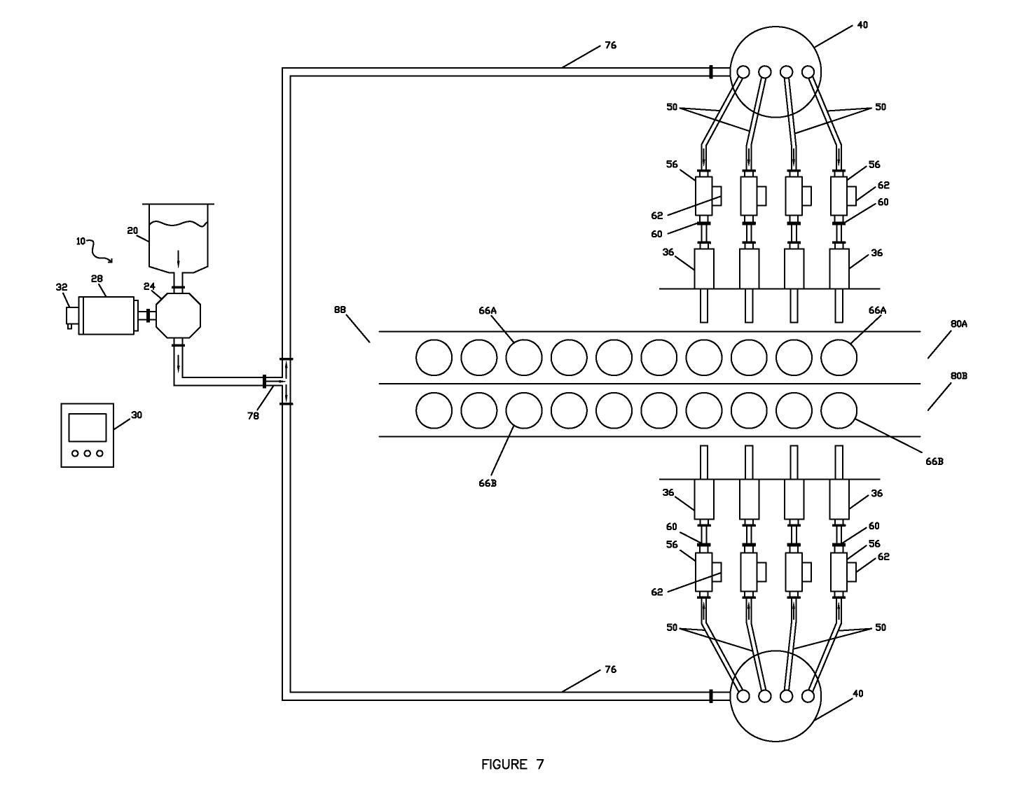

Referring now to FIG. 7, a dual lane filling machine has two lanes 80A, 80B of containers being filled by the liquid dosing apparatus. Dual lane fillers allow increased machine output speeds (measured in containers per minute) compared with single lane configurations.

In the embodiment shown in FIG. 7, the master dose produced by master dose pump 24 or by liquid flow meter 70 (as shown in FIG. 2) can be directed to one of two or more side branches 76 by means of the flow fitting 78, where the flow fitting 78 divides the liquid flow, directing it into one of a plurality of the side branches 76. Flow fitting 78 may be a tee fitting or any other appropriate configuration that allows the flow to be directed to side branches 76. Each side branch 76 out of the flow fitting 78 leads to a complete dosing apparatus. Each complete dosing apparatus consists of a dose distributor 40, adjustable dose controls 56, and filling heads 36.

The two complete dosing apparatuses may operate alternately. When the first apparatus 10A is delivering subdoses into a first set of containers 66A on the first lane 80A of conveyor 82, a second set of containers 66B are being indexed into filling positions on the second lane 80B of conveyor 82. With the completion of filling on first lane 80A, filling can begin on second lane 80B. In this arrangement, there is little or no delay in the start of filling due to container indexing at the appropriate location. This alternating sequencing confers much higher output speeds than could be realized on single lane configurations. With this embodiment, the calibration, setup and operating details set forth previously all apply.

The reductions in apparatus allowed when implementing a multi-position liquid dosing apparatus confers significant technical and commercial advantages. For example, the size of a filling machine is generally related to the scope of apparatus disposed on the filling machine. The liquid dosing apparatus 1 allows the filling machine to which it is fitted to be smaller than would otherwise be possible, while still demonstrating comparable performance. This size reduction is significant because functioning manufacturing square footage may be very expensive.

The burden of cleaning the liquid flow pathway of a liquid filling machine is a direct function of the scope and complexity of that pathway. Generally, the biggest reason for downtime or unproductive periods in production liquid fillers is cleaning time mandated by hygiene and by changeover from one product to another. Accordingly, the reduction in cleaning time, and the corresponding reduction in the amount of cleaning and rinsing liquid volumes may be economically and environmentally significant.

The consumption of electric power by an operating liquid filling machine is a significant portion of its cost of operation. The liquid dosing apparatus described herein may consume about one half of the electrical energy required of a comparable machine of known prior art design.

The initial capital cost of a production liquid filling machine may be significant, and the apparatus described herein, with significantly fewer components than in prior art designs, may allow a significant cost reduction when compared to a comparable machine of the prior art.

The need to expand or increase the speed and capacity of a filling machine in production service is common. Currently, capacity expansion is frequently not possible. Where it is possible, the size and configuration of the machine structure must anticipate expansion, and the expansion cost may be relatively high. To add a single filling position with conventional designs requires the use of a completely redundant dosing apparatus, including a pump and its associated drive mechanism, which may be the most expensive components in a filling position. To add an additional filling position to the liquid dosing apparatus disclosed herein requires only a changeout or alteration of the dose distributor and the addition of a dose control and filling head, which are of lower cost. Further, the compact footprint of the existing machine need not be initially larger or increased to allow addition of filling positions.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claims. In this regard, the terms as used in the claims are intended to include not only the designs illustrated in the drawings of this application and the equivalent designs discussed in the text, but are also intended to cover other equivalents now known to those skilled in the art, or those equivalents which may become known to those skilled in the art in the future.

1. An apparatus for dosing a plurality of containers comprising:
a fluid supply;
a dosing pump capable of producing repeatable, substantially identical master doses of fluid on each dosing cycle of the dosing pump;
a dose distributor with an inlet and a plurality of outlets;
a plurality of branches, wherein each of the plurality of branches extends from one of the plurality of outlets of the dose distributor, and wherein at least one of the plurality of branches comprises a filling head and a dose control; and
a fluid flow pathway extending from the dosing pump through the dose distributor, through the plurality of branches, and through the least one dose control;
wherein, during operation, each of the plurality of branches is in fluid communication with the dose distributor; and
wherein each of the plurality of containers is substantially simultaneously and substantially equally filled on each dosing cycle.

2. The apparatus of claim 1, wherein each of the plurality of branches has a filling head and an adjustable dose control; wherein each filling head defines a filling position; wherein each of the adjustable dose controls operates substantially synchronously with each of the other adjustable dose controls; and wherein each adjustable dose control defines a subdose to be delivered to a container.

3. The apparatus of claim 2, wherein, in operation, the dosing pump, the dose distributor, the plurality of dose controls, and the plurality of branches are all hydraulically connected.

4. The apparatus of claim 2, wherein the dosing pump is a positive displacement pump.

5. The apparatus of claim 2, wherein the dosing pump is an adjustable dosing pump.

6. The apparatus of claim 2, wherein adjustments to the adjustable dose controls can be made manually or automatically.

7. The apparatus of claim 2, wherein, in operation, the dosing pump provides the master dose to the dose distributor; wherein the dose distributor divides the master dose into a plurality of subdoses; and wherein each of the subdoses is dispensed into a container through one of the plurality of branches, plurality of adjustable dose controls, and plurality of filling heads.

8. The apparatus of claim 2, wherein each of the plurality of branches is configured substantially identically to one another; wherein each of the branches has a length; and wherein the length of each branch is within two percent of the length of each of the other branches.

9. The apparatus of claim 2, wherein the apparatus can be configured to include additional filling positions by changing or modifying the dose distributor, and adding a dose control, a filling head, and a branch for each additional container to be filled; and wherein each added branch is in hydraulic communication with the associated dose control.

10. The apparatus of claim 2, further comprising an alarm; wherein the dose controls are operated synchronously; and wherein the alarm is configured to alarm if the dose controls get out of sync with one another.

11. The apparatus of claim 2, wherein a single Coriolis liquid mass flow meter is disposed between an output of the dosing pump and the dose distributor; wherein the Coriolis liquid mass flow meter measures a mass of the master dose, wherein the Coriolis liquid mass flow meter generates pulses during operation; wherein the volume of the master dose is measured by a preset pulse count of the Coriolis liquid mass flow meter; wherein the mass of the master dose is equivalent to the sum of the masses of the plurality of the subdoses; and wherein each subdose is approximately equal in mass to each of the other subdoses.

12. The apparatus of claim 2, wherein a single volumetric liquid flow meter measures a volume of the master dose; wherein the volumetric liquid flow meter is disposed between an output of the dosing pump and the dose distributor; wherein the volumetric liquid flow meter generates pulses during operation; wherein the volume of the master dose is measured by a preset pulse count of the volumetric liquid flow meter; wherein the volume of the master dose is equivalent to the sum of the volumes of the plurality of the subdoses; and wherein each subdose is approximately equal in volume to each of the other subdoses.

13. The apparatus of claim 2, wherein the dosing pump and the plurality of dose controls are calibrated; wherein calibration and configuration data are stored electronically and used as operating set-up parameters.

14. The apparatus of claim 2, further comprising a sample dose filling head disposed between and in fluid communication with the master dose pump and the dose distributor, wherein the sample dose filling head is configured to allow the sampling and measurement of a master dose.

15. An apparatus for dosing a plurality of containers comprising:
a fluid supply;
a dosing pump;
a flow fitting;
a plurality of dose distributors, each dose distributor having one inlet and a plurality of outlets;
at least one dose control;
at least one filling head; and
a plurality of branches;
wherein each of the plurality of branches extends from one of the plurality of outlets of one of the plurality of dose distributors;
wherein at least one of the plurality of branches comprises a dose control and a filling head;
wherein a fluid flow pathway extends from the dosing pump to each of the plurality of dose distributors;
wherein the flow fitting diverts each master dose to one of the plurality of dose distributors;
wherein each of the plurality of dose distributors are substantially similar to one another.

16. The apparatus of claim 15, wherein each of the plurality of branches comprises an adjustable dose control and a filling head; wherein each filling head defines a filling position; wherein each of the adjustable dose controls operates substantially synchronously with each of the other adjustable dose controls; and wherein each adjustable dose control defines a subdose to be delivered to a container.

17. A method of dosing a plurality of containers comprising the steps of:
providing a fluid supply, a dosing pump, a dose distributor with an inlet and a plurality of outlets, a plurality of branches, wherein each of the plurality of branches further comprises a dose control; wherein a fluid flow pathway extends from the dosing pump through the dose distributor, the plurality of branches, and the associated dose controls and filling heads; wherein the dosing pump is capable of producing repeatable, substantially identical master doses of fluid on each dosing cycle of the dosing pump;
activating the dosing pump, wherein the operation of the pump produces a master dose of a desired volume or weight while the pump is in operation, wherein the dosing pump provides the master dose to the dose distributor;
dividing the master dose into a plurality of approximately equal subdoses;
delivering a subdose to each of the plurality of branches and associated dose controls and filling heads;
activating the plurality of dose controls synchronously to deliver a subdose to each of a plurality of containers, wherein each of the plurality of containers is substantially simultaneously and substantially equally filled on each dosing cycle.

18. The method of claim 17, further comprising the step of providing a single Coriolis liquid mass flow meter, positioning the Coriolis liquid mass flow meter between an output of the dosing pump and the dose distributor wherein the Coriolis liquid mass flow meter defines and measures a mass of the master dose.

19. The method of claim 17, further comprising the step of providing a single volumetric liquid flow meter, positioning the volumetric liquid flow meter between an output of the dosing pump and the dose distributor wherein the volumetric liquid flow meter defines and measures a weight of the master dose.

20. The method of claim 17, further comprising adding at least one additional filling position by adding a dose control, a filling head, and a branch for each additional filling position, and exchanging or modifying the dose distributor to allow each added branch to be in fluid communication with the dose distributor.

21. The method of claim 17, wherein the branches may be grouped into two or more groups of branches, each group comprising the same number of branches; and further comprising the steps of adding the subdose to each of a plurality of containers when each of the plurality of containers is at a first indexed filling position; adding at least one additional subdose to each of the plurality of containers when the containers are at an additional indexed filling position; and wherein the subdose and all additional subdoses added to a container fill the container with a desired total amount of fluid.

22. The method of claim 17, further comprising the steps of: providing at least two separate container indexing lanes; dividing the output of the dose distributor into at least two equal portions; alternately dosing subdoses to container filling positions located on one of the at least two separate container indexing lanes.

23. The method of claim 17, further comprising the steps of calibrating the dosing pump and the plurality of dose controls, and of electronically storing configuration and calibration data for the dosing pump and the plurality of dose controls for subsequent operation of the dosing apparatus.
